(19) United States
(12) Patent Application Publication
(10) Pub. No.: US 2025/0260085 A1
(43) Pub. Date: Aug. 14, 2025

(54) THERMAL INTERFACE MATERIAL INSTALLATION WITHIN A TRACTION BATTERY PACK

(71) Applicant: Ford Global Technologies, LLC, Dearborn, MI (US)

(72) Inventors: Rajaram Subramanian, Ann Arbor, MI (US); Hari Krishna Addanki, Novi, MI (US); Steve Droste, Canton, MI (US); Suriyaprakash Ayyangar Janarthanam, Canton, MI (US)

(21) Appl. No.: 18/436,195

(22) Filed: Feb. 8, 2024

(51) Int. Cl. H01M 10/653; H01M 10/625; H01M 10/6556; H01M 50/244

(52) U.S. Cl. CPC H01M 10/653; H01M 10/625; H01M 10/6556; H01M 50/244; H01M 2220/20

(57) ABSTRACT

A method of assembling components of a traction battery includes dispensing a thermal interface material onto a release sheet. While the thermal interface material remains on the release sheet, the method applies the thermal interface material to a component of a traction battery pack. The method then separates the release sheet from the thermal interface material while the thermal interface material remains on the component of the traction battery pack.

### TECHNICAL FIELD

This disclosure relates generally to a traction battery pack and, more particularly, to how thermal interface material (TIM) is installed within the traction battery pack.

### BACKGROUND

Electrified vehicles differ from conventional motor vehicles because electrified vehicles can be selectively driven by one or more electric machines that are powered by a traction battery pack. The electric machines can propel the electrified vehicles instead of, or in combination with, an internal combustion engine. Thermal interface materials can be used in various areas of traction battery packs to facilitate management of thermal energy.

### SUMMARY

In some aspects, the techniques described herein relate to a method of assembling components of a traction battery, including: dispensing a thermal interface material onto a release sheet; while the thermal interface material remains on the release sheet, applying the thermal interface material to a component of a traction battery pack; and separating the release sheet from the thermal interface material while the thermal interface material remains on the component of the traction battery pack.

In some aspects, the techniques described herein relate to a method, wherein the component is a thermal exchange plate.

In some aspects, the techniques described herein relate to a method, further including, after the separating, sandwiching the thermal interface material between the thermal exchange plate and a battery array.

In some aspects, the techniques described herein relate to a method, further including communicating a liquid coolant through coolant channels of the thermal exchange plate.

In some aspects, the techniques described herein relate to a method, further including, after the separating, supporting at least one battery array on the component.

In some aspects, the techniques described herein relate to a method, further including, during the applying of the thermal interface material to the component, compressing the thermal interface material against the component.

In some aspects, the techniques described herein relate to a method, further including dispensing the thermal interface material as a bead.

In some aspects, the techniques described herein relate to a method, wherein the thermal interface material is silicone-based.

In some aspects, the techniques described herein relate to a method, further including, after the dispensing, heating the release sheet to heat the thermal interface material.

In some aspects, the techniques described herein relate to a method, after the dispensing, transporting the thermal interface material on the release sheet using a conveyer assembly to a position closer to the component.

In some aspects, the techniques described herein relate to a method, further including gripping peripheral edges of the release sheet with the conveyer assembly.

In some aspects, the techniques described herein relate to a method, further including applying the thermal interface material by operating the conveyer assembly.

In some aspects, the techniques described herein relate to a method, wherein the release sheet is a first release sheet and further including dispensing a bead of the thermal interface material on the first release sheet and a second release sheet.

In some aspects, the techniques described herein relate to a method, wherein the first release sheet and the second release sheet are conveyor slats.

In some aspects, the techniques described herein relate to a traction battery assembly, including: a release sheet; and a thermal interface material deposited on the release sheet, the release sheet configured to be separated from the thermal interface material after applying the thermal interface material to a traction battery component.

In some aspects, the techniques described herein relate to a traction battery assembly, wherein the traction battery component is a thermal exchange plate.

In some aspects, the techniques described herein relate to a traction battery assembly, wherein the release sheet is a heated release sheet configured to heat the thermal interface material deposited on the heated release sheet.

In some aspects, the techniques described herein relate to a traction battery assembly, further including a conveyer assembly that grips the release sheet, the conveyer assembly configured to move the release sheet and the thermal interface material closer to the component.

In some aspects, the techniques described herein relate to a traction battery assembly, wherein the release sheet is a first release sheet, and wherein the thermal interface material is a bead of thermal interface material that is deposited on the first release sheet and a second release sheet.

In some aspects, the techniques described herein relate to a traction battery assembly, wherein the release sheet is a conveyor slat.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle according to an exemplary aspect of the present disclosure.

FIG. 2 illustrates an expanded view of a battery pack from the electrified vehicle of FIG. 1.

FIG. 3 illustrates a thermal interface material being dispensed on a release sheet.

FIG. 4 illustrates the thermal interface material being applied to a component of the battery pack of FIG. 2.

FIG. 5 illustrates the thermal interface material after being applied to a component of the battery pack of FIG. 2.

FIG. 6 illustrates the release sheet being removed from the thermal interface material.

FIG. 7 illustrates a system of applying the thermal interface material to the release sheet and then to the component according to another exemplary embodiment of the present disclosure.

### DETAILED DESCRIPTION

A traction battery pack can include a thermal interface material (TIM) in many areas. For example, TIM can be applied between a two components of the traction battery pack to facilitate thermal energy exchange between the two components.

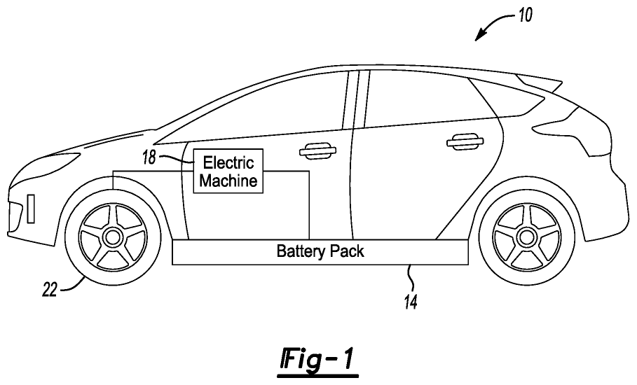

With reference to FIG. 1, an electrified vehicle 10, in an exemplary non-limiting embodiment, includes a traction battery pack 14 that powers an electric machine 18. The electrified vehicle 10 further includes wheels 22 driven by the electric machine 18. The battery pack 14 can power the electric machine 18, which converts electric power to torque to drive the wheels 22.

The battery pack 14 is, in the exemplary embodiment, secured to an underbody 26 of the electrified vehicle 10. The battery pack 14 could be located elsewhere on the electrified vehicle 10 in other examples. The battery pack 14 can be secured to the underbody 26 using straps and mechanical fasteners, for example.

The electrified vehicle 10 is an all-electric vehicle. In other examples, the electrified vehicle 10 is a hybrid electric vehicle, which can selectively drive wheels using torque provided by an internal combustion engine instead, or in addition to, an electric machine. Generally, the electrified vehicle 10 could be any type of vehicle having a traction battery pack.

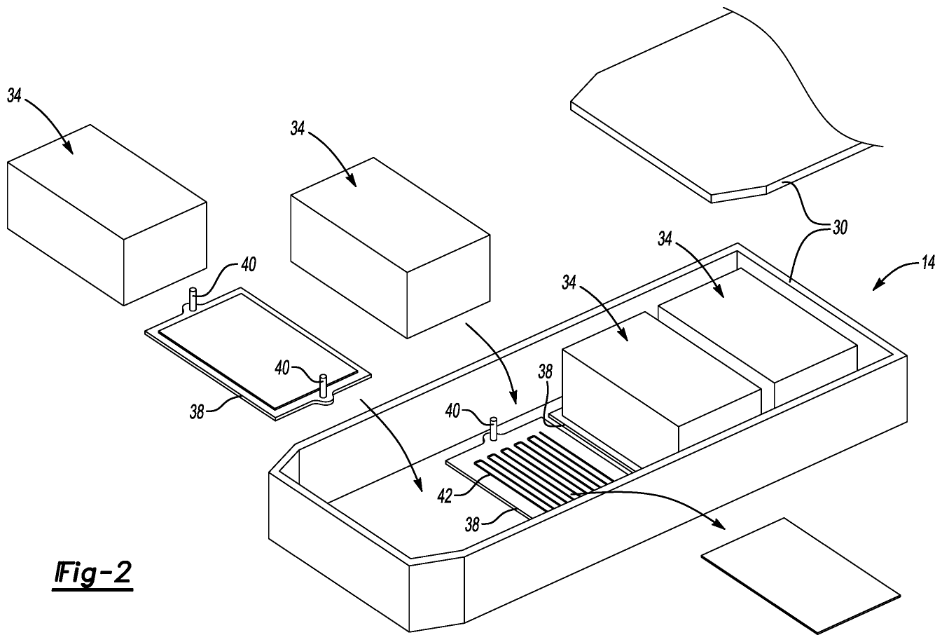

Referring now to FIG. 2, the battery pack 14 includes an enclosure 30 that encloses a plurality of battery arrays 34 each having an associated thermal exchange plate 38. In other examples, a single thermal exchange plate 38 is associated with more than one of the battery arrays 34. The battery arrays 34 include, among other things, a plurality of battery cells.

To manage thermal energy levels within the battery arrays 34 and other areas of the traction battery pack 14, coolant can be circulated between the coolant supply and the coolant channels within the thermal exchange plate 38. The coolant can be a liquid coolant. The thermal exchange plate 38, often referred to as a “cold plate,” can be used to dissipate thermal energy. The thermal exchange plates 38 each include conduits 40 that provide inlets for the coolant to the thermal exchange plate 38 and outlets from the thermal exchange plate 38 for the coolant. Other conduits communicate coolant back and forth between conduits and the coolant supply. These conduits are omitted in FIG. 2.

In this example, a thermal interface material (TIM) 42 can be used to facilitate thermal conductivity between the battery arrays 34 and the respective thermal exchange plate 38. In the past, during assembly of the battery pack 14, a bead of the TIM 42 was typically dispensed from a TIM dispenser directly onto the thermal exchange plate 38 in a desired pattern, which contributed toward cycle times.

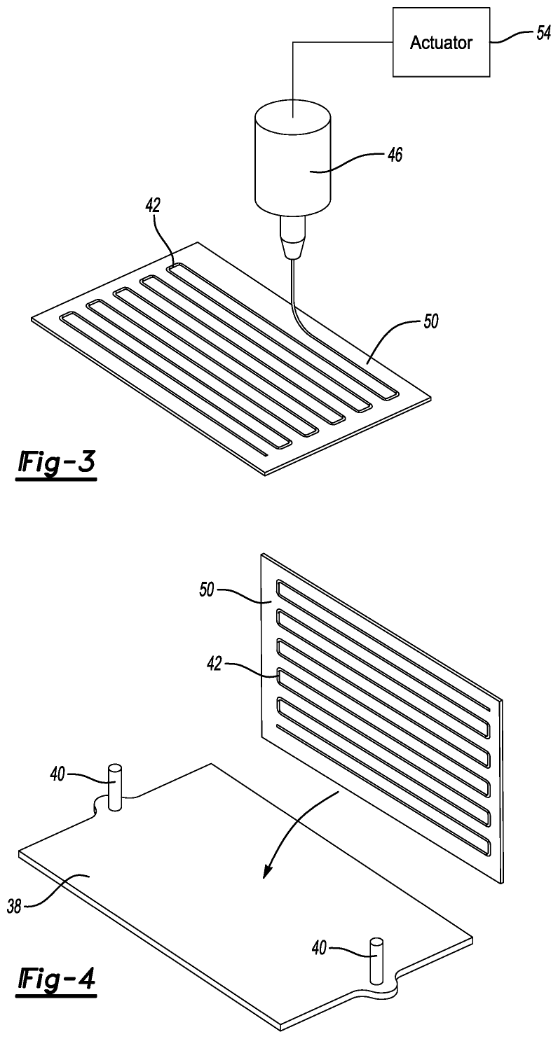

With reference to FIG. 3, in an exemplary process of this disclosure, the TIM 42 is dispensed from a TIM dispenser 46 onto a release sheet 50. The TIM 42 is dispensed as a bead of TIM 42. The TIM 42 is dispensed into a desired pattern-here a circuitous pattern. An actuator 54, such as a three-axis linear actuator, can be used to move the TIM dispenser 46 relative to the release sheet 50 to dispense the TIM 42 in a desired pattern. The TIM 42 can be silicone-based.

Next, as shown in FIG. 4, the release sheet 50 and the TIM 42 are moved closer to a component of the traction battery pack 14 of FIG. 2. In this example, the component is one of the thermal exchange plates 38 from the battery pack 14. The release sheet 50 with the TIM 42 in a bead form is rotated so that the TIM 42 can be applied directly to the thermal exchange plate 38. When the TIM 42 is initially applied to the thermal exchange plate 38, the bead of the TIM 42 is sandwiched between the release sheet 50 and the thermal exchange plate 38. The release sheet 50 with the TIM 42 are flipped to move to the position of FIG. 4.

In some examples, when the TIM 42 is applied to the thermal exchange plate 38, the TIM 42 and the release sheet 50 may be compressed into the thermal exchange plate 38. The moving of the TIM 42 and the release sheet 50 toward the component of the battery pack 14 can be an automated movement that utilizes a vacuum assist and release mechanism.

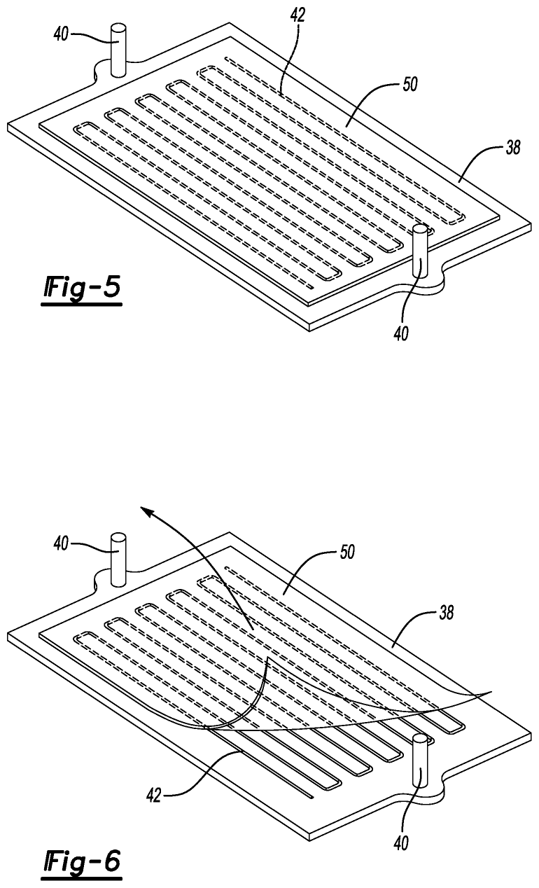

As shown in FIG. 5, when the TIM 42 is initially applied to the thermal exchange plate 38, the bead of TIM 42 is sandwiched between the release sheet 50 and the thermal exchange plate 38.

Next, with reference to FIG. 6, the release sheet 50 is then peeled away from the TIM 42 while the TIM 42 remains applied to the thermal exchange plate 38. The TIM 42, release sheet 50, and thermal exchange plate 38 can be designed so that a bond between the TIM 42 and the thermal exchange plate 38 is stronger than a bond between the TIM 42 and the release sheet 50. This can facilitate maintaining the TIM 42 on the thermal exchange plate 38 as the release sheet 50 is removed.

As shown in FIG. 2, one of the battery arrays 34 is then positioned atop the thermal exchange plate 38 and the TIM 42 such that the TIM 42 is sandwiched between the thermal exchange plate 38 and the battery array 34. The TIM 42 is compressed by the battery array 34 into a thin layer of TIM 42. The battery array 34 is then supported on the thermal exchange plate 38 with the TIM 42 sandwiched therebetween. The TIM 42 facilitates thermal transfer between the battery array 34 and the thermal exchange plate 38.

In some examples, the release sheet 50 is polytetrafluoroethylene (PTFE) or similar type of material.

In some examples, the release sheet 50 is a heated release sheet that includes heating embedded or imprinted wires. Heating the release sheet 50 heats the TIM 42, which in some examples can ensure thermal energy levels in the TIM 42 are at levels appropriate for application to the thermal exchange plate 38.

The dispensing of the TIM 42 on the release sheets 50 and subsequent transfer to the thermal exchange plate 38 can shorten the manufacturing process as waiting for a dispensing of the TIM 42 on the thermal exchange plate 38 is not adding to an overall cycle time. Multiple beads of TIM 42 can be dispensed on respective release sheets 50 and staged for application to the thermal exchange plate 38. The multiple beads of TIM 42 can be dispensed simultaneously if required such that the dispensing time of the TIM 42 does not substantially contribute to overall cycle time.

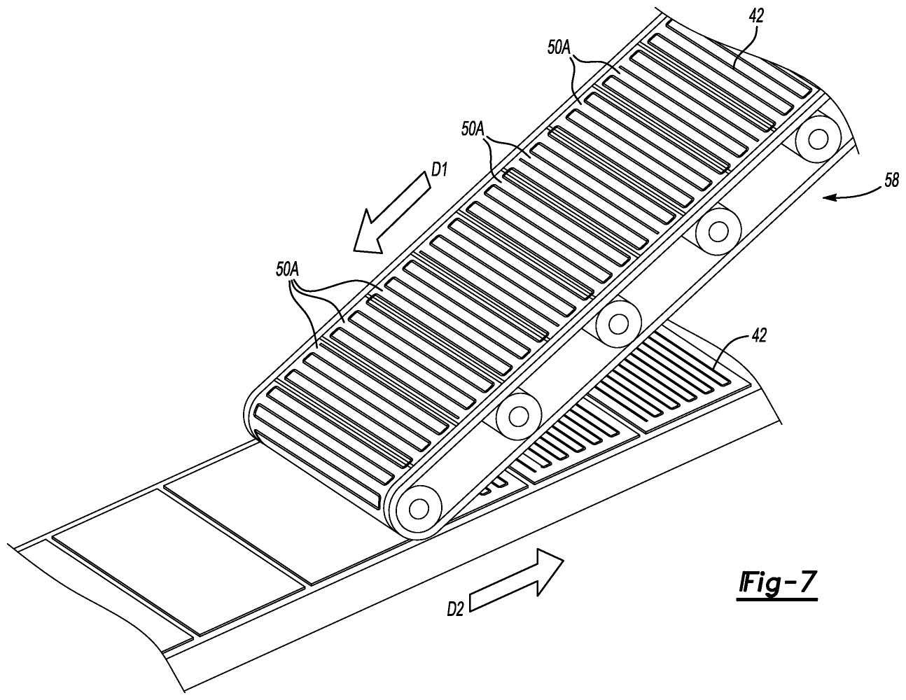

Another method of transporting the TIM 42 and the release sheet 50 to the location of the component, here the thermal exchange plate 38, could be utilized in other examples. In the example of FIG. 7, the release sheets 50A are incorporated into a conveyor assembly 58. The release sheets 50A can be conveyor slats. The release sheets 50A could instead or additionally rest on the conveyor assembly 58. Peripheral edges of the release sheets 50A can be gripped by the conveyor assembly 58. The TIM 42 intended for application to a single component of the traction battery pack 14 can span over more than one of the slats or release sheets 50A. As the conveyor assembly 58 is operated, the release sheets 50A with the applied TIM 42 move in a direction D1.

In connection with the conveyor assembly 58, the thermal exchange plate 38 can be moved in a direction D2 near an end of the conveyor assembly 58. The thermal exchange plate 38 can be moved by a conveyor. As the release sheets 50A with the TIM 42 rotate about the end of the conveyor assembly 58, the TIM 42 is compressed into one of the thermal exchange plate 38. The continued rotation of the conveyor assembly 58 and movement of the thermal exchange plates 38 in the direction D2 separates the release sheet 50A from the TIM 42 leaving the TIM 42 applied to the thermal exchange plate 38.

The release sheet 50A from which the TIM 42 was removed can then be rotated back by the conveyor assembly 58 to a position near a TIM dispenser where another bead of TIM 42 can be applied to the release sheet 50A.

This automated process can reduce overall assembly cycle time even further by automating the transfer of the TIM 42 from the release sheet 50A to the thermal exchange plate 38.

Features of the disclosed examples include a process of positioning a TIM within a battery pack where the TIM is dispensed on a release sheet and then moved into a position where the TIM is bonded to a desired component. Dispensing onto the release sheet can reduce overall cycling time.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A method of assembling components of a traction battery, comprising:
dispensing a thermal interface material onto a release sheet;
while the thermal interface material remains on the release sheet, applying the thermal interface material to a component of a traction battery pack; and
separating the release sheet from the thermal interface material while the thermal interface material remains on the component of the traction battery pack.

2. The method of claim 1, wherein the component is a thermal exchange plate.

3. The method of claim 2, further comprising, after the separating, sandwiching the thermal interface material between the thermal exchange plate and a battery array.

4. The method of claim 3, further comprising communicating a liquid coolant through coolant channels of the thermal exchange plate.

5. The method of claim 1, further comprising, after the separating, supporting at least one battery array on the component.

6. The method of claim 1, further comprising, during the applying of the thermal interface material to the component, compressing the thermal interface material against the component.

7. The method of claim 1, further comprising dispensing the thermal interface material as a bead.

8. The method of claim 1, wherein the thermal interface material is silicone-based.

9. The method of claim 1, further comprising, after the dispensing, heating the release sheet to heat the thermal interface material.

10. The method of claim 1, after the dispensing, transporting the thermal interface material on the release sheet using a conveyer assembly to a position closer to the component.

11. The method of claim 10, further comprising gripping peripheral edges of the release sheet with the conveyer assembly.

12. The method of claim 11, further comprising applying the thermal interface material by operating the conveyer assembly.

13. The method of claim 1, wherein the release sheet is a first release sheet and further comprising dispensing a bead of the thermal interface material on the first release sheet and a second release sheet.

14. The method of claim 13, wherein the first release sheet and the second release sheet are conveyor slats.

15. A traction battery assembly, comprising:
a release sheet; and
a thermal interface material deposited on the release sheet, the release sheet configured to be separated from the thermal interface material after applying the thermal interface material to a traction battery component.

16. The traction battery assembly of claim 15, wherein the traction battery component is a thermal exchange plate.

17. The traction battery assembly of claim 15, wherein the release sheet is a heated release sheet configured to heat the thermal interface material deposited on the heated release sheet.

18. The traction battery assembly of claim 15, further comprising a conveyer assembly that grips the release sheet, the conveyer assembly configured to move the release sheet and the thermal interface material closer to the component.

19. The traction battery assembly of claim 15, wherein the release sheet is a first release sheet, and wherein the thermal interface material is a bead of thermal interface material that is deposited on the first release sheet and a second release sheet.

20. The traction battery assembly of claim 15, wherein the release sheet is a conveyor slat.
